(19) United States
(12) Patent Application Publication
(10) Pub. No.: US 2008/0047527 A1
(43) Pub. Date: Feb. 28, 2008

(54) Intensified common rail fuel injection system and method of operating an engine using same

(76) Inventors: Jinhui Sun, Bloomington, IL (US); Dennis Gibson, Chillicothe, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/510,311

(22) Filed: Aug. 25, 2006

(51) Int. Cl. F02M 47/02; F02M 59/46

(52) U.S. Cl. 123/446; 239/88; 123/467

(57) ABSTRACT

Extremely high injection pressures are achieved in a common rail fuel injection system via a movable intensifier positioned in each fuel injector. The fuel injectors are individually controlled via a single electrical actuator that moves between positions that connect an intensifier control cavity either to the high pressure common rail or a low pressure reservoir. Leakage is avoided between injection events by maintaining opposing hydraulic surfaces of the intensifier and needle valve exposed to fluid pressure in the high pressure rail. This avoids pressure differentials and leakage associated with guide surfaces separating high and low pressure areas.

### TECHNICAL FIELD

The present disclosure relates generally to fuel systems for compression ignition engines, and more particularly to a two wire electronically controlled intensified fuel injector for a common rail fuel system.

### BACKGROUND

Engineers are constantly seeking ways to operate fuel systems for compression ignition engines in a way that reduces emissions without sacrificing efficiency. One strategy that has met with considerable success in this regard is the introduction of electronically controlled unit injectors that allow fuel injection timing and quantity to be controlled independent of engine crank angle. These trends have continued to the point that many fuel injectors include two or more separate electrical actuators in order to provide a wide variety of fuel injection capabilities. These expanded capabilities can allow evermore control over timing, quantity, injection rate shape, injection pressures and other factors known in the art to achieve ever lower emissions across an engine's operating range. For instance, co-owned U.S. Pat. No. 6,725,838 discloses a fuel injection system in which each fuel injector has two separate electrical actuators, a direct control needle and an intensifier piston so that fuel can be injected at high and even higher injection pressures. In the disclosed system, timing can be somewhat controlled independent of fuel pressure, and different spray patterns allow for a wide variety of fuel injection strategies to reduce emissions without sacrificing efficiency. Another strategy reflected by the above identified fuel injection system, and many others in use today, is to seek ever higher injection pressures by utilizing a common pressurized fuel rail strategy and/or pressure intensification within the individual fuel injectors. For instance, both the '838 patent and U.S. Pat. No. 6,453,875 show fuel injection systems that include a common pressurized fuel rail that allow for injection at the rail pressure, and also provide an intensifier strategy that allows for fuel to be injected at a substantially higher pressure by moving an intensifier piston within the individual fuel injectors during an injection event. While these rather complicated fuel injection systems appear to offer an ever expanding fuel injection pallet of choices, they tend to be difficult to consistently manufacture, add additional complexity to control systems, and have yet to demonstrate the long term reliability and robustness demonstrated by simpler fuel injection systems of the past.

One problem that has often plagued common rail fuel systems is leakage. Those skilled in the art recognize that expending energy to pressurize fuel in a common rail to injection pressure levels, and then losing any substantial amount of that pressurized fuel to leakage is inefficient. Leakage can often occur in fuel injectors where a low pressure space is separated from a high pressure space by a guide surface, such as one associated with a needle valve or plunger. Leakage can sometimes occur between injection events due to fuel injector structures that maintain only a portion of the fuel injector pressurized between injection events. In other instances, such as that demonstrated by the direct control needle valve disclosed in the '875 patent, leakage is an accepted consequence of performing an injection event. For instance, some fuel injectors open and close their needles to open and close their nozzle outlets by directly connecting the high pressure common rail to a low pressure drain via a needle top cavity during an injection event. While the use of so called A and Z orifices can reduce the leakage rates necessary to perform the control function, the leakage nevertheless demonstrates a substantial inefficiency in the operation of certain fuel injection systems.

Another type of intensified fuel injection system that has demonstrated robustness and considerable success for many years is disclosed in co-owned U.S. Pat. No. 5,121,730. This fuel injection system utilizes medium pressure oil to push an intensifier piston to pressurize fuel to injection levels. Although this type of fuel injection system has performed magnificently for many years, it appears to lack the ability to achieve the ever increasing injection pressure levels currently being requested in the industry. It must also compensate for viscosity variations in the oil due to extremes in temperature, such as at cold start. In addition, the disclosed system has the draw back of maintaining two separate fluid circuits, one associated with actuation fluid (oil) and another associated with circulating fuel among the fuel injectors.

The present disclosure is directed to one or more of the problems set forth above.

### SUMMARY OF THE INVENTION

In one aspect, a fuel injector includes an intensifier control cavity, a plunger cavity, an actuation cavity, a needle top cavity and a nozzle cavity disposed in an injector body, which defines a high pressure inlet, a low pressure drain and a nozzle outlet. A needle fluidly separates a needle top cavity from the nozzle cavity, and is movable between a first position in which the nozzle outlet is fluidly connected to the nozzle cavity, and the second position at which the nozzle cavity is blocked from the nozzle outlet. An intensifier fluidly separates the intensifier control cavity, the plunger cavity and the actuation cavity from each other. An electronic control valve is at least partially disposed in the injector body, and is movable between a first position at which the intensifier control cavity is fluidly connected to the high pressure inlet, and a second position at which the intensifier cavity is fluidly connected to the low pressure drain. A check valve fluidly separates the high pressure inlet from the plunger cavity. Unobstructed passages fluidly connect the needle top cavity and the actuation cavity to the high pressure inlet.

In another aspect, a fuel injection system includes a high pressure common rail, a low pressure reservoir and a plurality of fuel injectors that each include a needle top cavity and an actuation cavity fluidly connected via unobstructed passages to the high pressure common rail. An electronic control valve is associated with each fuel injector, and is movable between a first position at which the intensifier control cavity is fluidly connected to the high pressure common rail, and a second position at which the intensifier control cavity is fluidly connected to the low pressure reservoir. The fuel injectors each include an intensifier and a needle with opposing hydraulic surfaces separated by guide surfaces and exposed to fluid pressure in the high pressure common rail when the electronic control valve is at the first position.

In still another aspect, a method of operating an engine includes compressing air in an engine cylinder beyond an auto-ignition point of a liquid fuel. Opposing hydraulic surfaces of an intensifier of a plurality of fuel injectors are maintained exposed to fuel pressure in the high pressure common rail between injection events. A fuel injection event is initiated by fluidly connecting an intensifier control cavity to a low pressure reservoir via an electronic control valve. Fuel pressure is raised above that of the high pressure common rail during an injection event by moving the intensifier within the respective fuel injectors. A needle top cavity is maintained at the fuel pressure of the high pressure common rail between and during injection events.

### BRIEF DESCRIPTION OF THE DRAWINGS

FIG. 1 is a schematic view of an engine having a fuel injection system according to the present disclosure; and

FIG. 2 is a schematic side sectioned view of a fuel injector according to the present disclosure.

### DETAILED DESCRIPTION

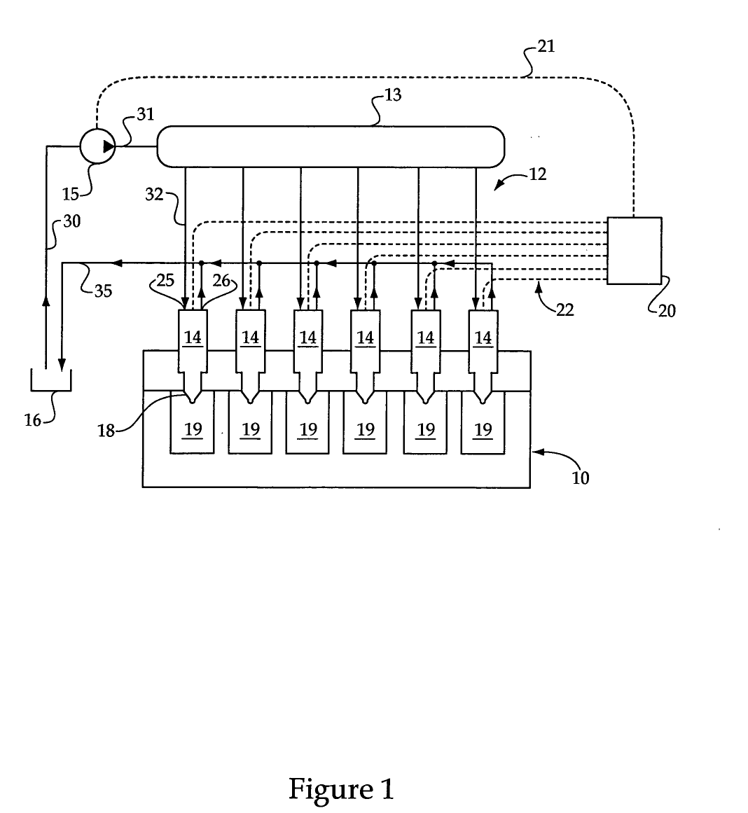

Referring to FIG. 1, an engine 10 includes a common rail fuel system 12 that includes a fuel injector 14 associated with each of a plurality of cylinders 19. In particular, each fuel injector 14 includes a fuel injector tip 18 positioned for direct injection of fuel into the individual cylinders 19. The fuel may be compression ignited in a conventional manner in each of the individual cylinders 19. Although the illustration shows an engine 10 with six cylinders, the present disclosure is applicable to an engine with any number of cylinders. Engine 10 is controlled in a conventional manner via an electronic control module(s) 20 that communicates with an individual fuel injectors 14 via communication lines 22, and communicates with a high pressure pump 15 to control fuel pressure in a high pressure common rail 13 via a communication line 21. The common rail fuel system 12 includes a low pressure reservoir 16 that supplies low pressure fuel to high pressure pump 15 via a pump supply line 30, which may include a transfer pump, filters, coolers and the like (not shown). High pressure pump is controlled to supply pressurized fuel to common rail 13 via rail supply line 31. Each of the individual fuel injectors 14 communicates with high pressure common rail 13 via individual rail branch passages 32 that are connected at high pressure inlets 25 of each fuel injector 14. Low pressure fuel leaves the individual fuel injectors 14 via low pressure drains 26 that empty into a low pressure return line 35 that is fluidly connected back to the low pressure reservoir 16 for recirculation. Common rail 13 may be equipped with a pressure relief valve (not shown) that could avoid over pressurization by routing excess fuel back to low pressure reservoir 16.

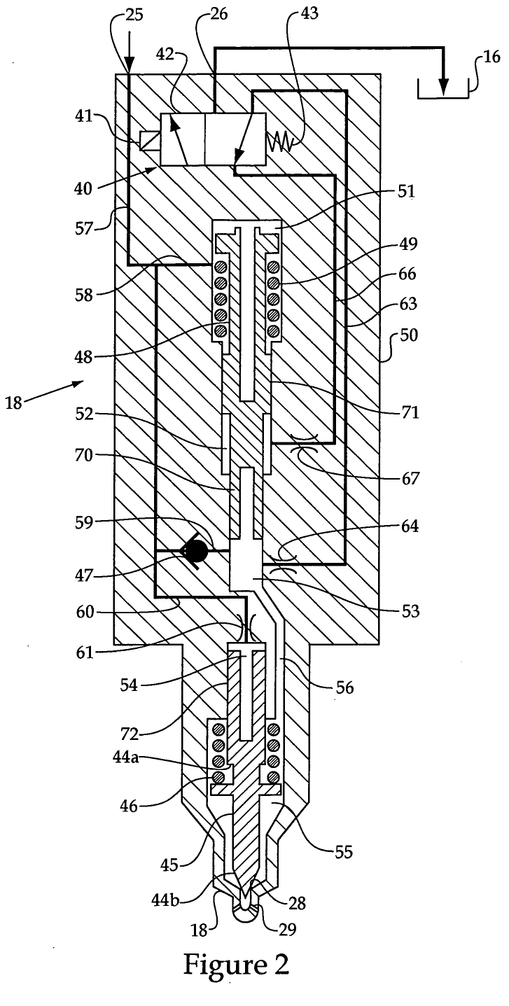

Each fuel injector 14 is equipped with only a single electronic control valve 40 that includes an electrical actuator 41 coupled to move a valve member 42 against the action of a biasing spring 43. Those skilled in the art will appreciate that electronic control valve 40 may be a poppet type valve that avoids leakage by a fluid tight seal associated with a one or more conical valve seats. Thus, valve member 42 could be trapped to move between a high pressure conical valve seat and a low pressure conical valve seat by the action of biasing spring 43 and electrical actuator 41 in a manner well known in the art. Alternatively, valve member 42 could be moved via a pilot valve connected to electrical actuator 41 without departing from the present disclosure. Fuel injector 14 includes an injector body 15 having disposed therein several components and a variety of passageways and cavities in order to allow for the injection of fuel to the individual engine cylinder 19 at a pressure greater than that in common rail 13. In particular, an intensifier control cavity 52, a plunger cavity 53, an actuation cavity 51, a needle top cavity 54 and a nozzle cavity 55 are all disposed in the injector body 50. In addition, the injector body 50 defines high pressure inlet 25, a low pressure drain 26 and a nozzle outlet 29. The nozzle cavity 55 is fluidly connected via an unobstructed nozzle supply passage 56 to plunger cavity 53. In terms of the present disclosure, the term “unobstructed” means that no valve that can completely close the passageway is positioned in the passageway. Thus, an unobstructed passageway can include a flow restriction, but does not include either an electronically controlled or passive valve that may completely shut the passageway. For instance, plunger cavity 53 is also connected to high pressure line 57 via a plunger fill passage 59 that includes a check valve 47. Thus, in the context of the present disclosure, plunger fill passage 59 could not be considered as unobstructed. As shown in FIG. 2, the originating end of high pressure line 57 is fluidly connected to high pressure inlet 25. An unobstructed actuation branch passage 58 fluidly connects high pressure line 57 to actuation cavity 51. Thus, actuation cavity 51 is always fluidly connected to high pressure common rail 13 via branch passage 58, high pressure line 57 and rail branch passage 32. Likewise, needle top cavity 54 is always fluidly connected to high pressure line 57 and hence common rail 13 via a pressure communication line 60, that may include a restricted orifice 61, if desired.

Fuel injector 14 also includes an intensifier 48 that may be composed of one or more components to slide between a retracted position, as shown, and an advanced downward position. Intensifier 48 is normally biased toward its retracted position by a return spring 49, which is positioned in actuation cavity 51. Those skilled in the art will appreciate that return spring 49 could be positioned elsewhere to bias intensifier 48 toward its retracted position in a known manner. Intensifier 48 is guided in its movement between its retracted and advanced positions by annular guide surfaces 70 and 71 that define a relatively tight guide clearance fit between the intensifier and the internal walls of injector body 50. Thus, intensifier 48 and guide surfaces 70 and 71 can be thought of as fluidly separating the intensifier control cavity 52, actuation cavity 51 and plunger cavity 53 from each other. Intensifier 48 may include hollow portions adjacent guide portions 70 and 71 that may be exploited to reduce the guide clearance in those areas when high pressure slightly radially expands the intensifier during times when a pressure differential exists between one or more of the actuation cavity 51, intensifier control cavity 52 and plunger cavity 53. When the electronic control valve 40 is in its biased first position as shown, plunger cavity 53 is fluidly connected to intensifier control cavity 52 via fluid line 63 and control line 66. Fuel injector 14 is shown with intensifier 48 and electronic control valve 40 positioned as they would be between injection events. A fluid connection between plunger cavity 53 and intensifier control cavity 52 causes all of the internal cavities (actuation cavity 51, intensifier control cavity 52, plunger cavity 53, needle top cavity 54 and nozzle cavity 55) to be at the same pressure as common rail 13 between injection events. This prevents pressure differentials across guide portions 70 and 71 during the prolonged period between injection events, thus avoiding leakage along those guide surfaces sometimes observed in other fuel injection systems that maintain a pressure differential between injection events. When electrical actuator 41 moves control valve member 42 to its second position, intensifier control cavity 52 becomes fluidly connected to low pressure drain 26. When this occurs, the hydraulic force in actuation cavity 51 causes the intensifier 48 to move downward toward its advanced position against the action of return spring 49 to raise fuel pressure in plunger cavity 53 above that in common rail 13 according to the strength of spring 49 and the diameter ratios associated with the intensifier 48 in a manner well known in the art. When this occurs, check valve 47 closes. Fluid line 63 and control line 66 may include respective restricted orifices 64 and 67 to achieve some desired action out of fuel injector 14. For instance, restricted orifice 67 could be employed to reduce the movement rate of the intensifier 48 during an injection event. On the other hand, one or both of restricted orifices 64 and 67 could be utilized to slow the retraction rate of intensifier 48 after an injection event when the fuel injector is resetting itself for a subsequent injection event, such as to avoid cavitation. Thus, those skilled in the art will appreciate that restricted orifices 64 and 67 may have the same or different flow areas, and one or both may be excluded all together from fuel injector 14 if desired.

Fuel injector 14 also includes a needle 45 disposed therein. Needle 45 is guided in its movement via a guide surface 72, which along with needle 45 separates needle top cavity 54 from nozzle cavity 55. Needle 45 is normally biased downward in contact with a seat 28 via a needle biasing spring 46 in a conventional manner. When needle 45 is in contact with seat 28, nozzle cavity 55 is blocked from fluid communication with nozzle outlet 29 in a conventional manner. When needle 45 lifts towards its open position against the action of needle biasing spring 46, a fluid connection is created between nozzle cavity 55 and nozzle outlet 29 allowing fuel to be sprayed into the individual engine cylinders 19. Needle 45 includes opening hydraulic surfaces 44a and 44b that are exposed to fluid pressure in nozzle cavity 55. Thus, when both top cavity 54 is at rail pressure, as it always is, and nozzle cavity 55 is also at rail pressure, such as between injection events, the needle 45 is held in its downward position to close seat 28 by the needle biasing spring 46. However, when intensifier 48 is driven downward to greatly increase fuel pressure in plunger cavity 53, the fluid pressure is communicated to nozzle cavity 55 via nozzle supply passage 58, and this higher pressure acts upon the opening hydraulic surfaces 44a and 44b to lift needle 45 upward against the action of biasing spring 46 toward its open position. Although spring 46 is shown in nozzle cavity 55, it could equally be located elsewhere, such as in needle top cavity 54. Those skilled in the art will appreciate that the valve opening pressure as well as the opening and closing rates of needle 45 can be engineered by selecting the magnitude of pressure in common rail 13, the area ratios of intensifier 48, and hence expected injection pressure in plunger cavity 53, while also appropriately sizing opening hydraulic surfaces 44a, and 44b while selecting an appropriate pre-load on needle biasing spring 46, and finally by including or excluding the restricted orifice 61.

### INDUSTRIAL APPLICABILITY

The fuel system of the present disclosure finds potential application in any internal combustion engine, but is particularly adapted to compression ignition engines wherein fuel is directly injected into individual engine cylinders 19 and compression ignited in a manner well known in the art. between injection events, electrical actuator 41 is de-energized and control valve member 41 is positioned in its first or biased position, as shown, via biasing spring 43. When this occurs, the intensifier control cavity 52 is fluidly connected to common rail 13 via control line 66, fluid line 63, check valve 47 positioned in plunger cavity 59 and high pressure line 57 and rail branch passage 32. Thus, the only pressure differential existing in fuel injector 14 between injection events occurs in electronic control valve 41. However, because this valve may include a poppet type valve member that seals a conical valve seat, no leakage occurs from fuel injector 14 between injection events. Likewise, no leakage occurs across needle 45 since it is securely seated at seat 28, and no pressure differential exists between needle top cavity 54 and nozzle cavity 55.

An injection event is initiated by electronic control module commanding the energization of electrical actuator 41 to move control valve member 42 from its first position, as shown, to its second position that fluidly connects intensifier control cavity 52 to low pressure drain 26 via control line 66. When this occurs, the rail pressure acting in actuation cavity 51 pushes intensifier 48 downward against the action of return spring 49 to raise fuel pressure in plunger cavity 53. When that pressure rises above a valve opening pressure for needle 45, it lifts to an open position against the action of needle biasing spring 46 to fluidly connect nozzle cavity 55 to nozzle outlets 29 to commence the spraying of fuel into engine cylinder 19. Shortly before the desired amount of fuel is injected, the control signal de-energizes electrical actuator 41 causing it to return to its first position under the action of biasing spring 43. This reconnects intensifier control cavity 52 to common rail 13 via control line 66, the fluid line 63, plunger cavity 53 and plunger fill passage 59. When this occurs, the fuel pressure in nozzle cavity 55 drops below a valve closing pressure and needle 55 is driven downward to re-seat on seat 28 via needle biasing spring 46. After the injection event, flow from rail 13 and fuel displaced from actuation cavity 51 allows intensifier 48 to retract under the action of return spring 49 to refill both plunger cavity 53 and intensifier control cavity 52 in preparation for a subsequent injection event.

As in a typical diesel engine, when fuel is combusted by compressing air in the engine cylinder 19 beyond an auto ignition point of the liquid fuel injected from fuel injector 14. Those skilled in the art will appreciate that the fuel may be injected into the cylinder before or after the air has been compressed above the auto ignition point. In a typical case, the air is compressed beyond an auto ignition point and the fuel is injected at or near top dead center for the piston associated with that individual cylinder. Nevertheless, the fuel system 12 of the present disclosure can accommodate so called homogeneous charge compression ignition mode of operation where fuel is injected into the engine cylinder and allowed to mix with air before being compressed beyond on the auto ignition point of the fuel.

Those skilled in the art will appreciate that the fuel system of the present disclosure leverages known technology associated with relatively high pressure common fuel rail systems. This leveraging is accomplished via the use of an intensifier to substantially increase injection pressures above that of the common rail, and only do so within the fuel injector for the brief duration of the injection event. While many current production common rail systems can achieve injection pressures on the order of 160-180 Mpa, it is generally recognized that there are significant structural challenges for the fuel system (pump, line rail, injector, pressure sensor, pressure regulator, etc.) to endure beyond 200 Mpa injection pressures for an entire engine life. However, the fuel system of the present disclosure has the ability to briefly raise fuel pressures only in the fuel injector well above 200 Mpa for relatively high pressure injections not currently possible with most common rail systems. And this is accomplished with a single electrical actuator. Those skilled in the art will appreciate that these extremely high pressures can be useful in further reducing undesirable engine emissions while without sacrificing engine performance. In addition, very high injection pressures can be achieved without sacrificing efficiency via substantial fuel leakage within the fuel injector between injection events. The only substantial losses are those associated with once pressurized fuel displaced from the intensifier control cavity 52 during an injection. In addition, while some leakage may occur along the guide surfaces 70, 71 and 72 during an injection event, that relatively small leakage can be further reduced, for instance, by utilizing a hollow plunger portion for intensifier 48 that reduces the guide clearance during the downward intensifier stroke to further reduce fuel migration and leakage along guide surface 70. Those skilled in the art will appreciate that by appropriate sizing of the area ratios and spring strike associated with needle 45 as well as restricted orifice 61, the fuel injection rate could be made more square or more ramp in a manner well known in the art. In addition, the structure of the present disclosure always facilitates a valve opening pressure higher than that in the common rail 13, and the orifice 61 adjacent needle top cavity 54 will regulate flow into and out of check top cavity 54, thus controlling the check opening and closings velocities.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

What is claimed is:

1. A fuel injector comprising:
an intensifier control cavity, a plunger cavity, an actuation cavity, a needle top cavity and a nozzle cavity disposed in an injector body, which defines a high pressure inlet, a low pressure drain and a nozzle outlet;
a needle fluidly separating the needle top cavity from the nozzle cavity, and being movable between a first position at which the nozzle outlet is fluidly connected to the nozzle cavity, and a second position at which the nozzle cavity is blocked from the nozzle outlet;
an intensifier fluidly separating the intensifier control cavity, the plunger cavity and the actuation cavity from each other;
an electronic control valve at least partially disposed in the injector body, and being movable between a first position at which the intensifier control cavity is fluidly connected to the high pressure inlet, and a second position at which the intensifier cavity is fluidly connected to the low pressure drain;
a check valve fluidly separating the high pressure inlet from the plunger cavity; and
unobstructed passages fluidly connecting the needle top cavity and the actuation cavity to the high pressure inlet.

2. The fuel injector of claim 1 wherein the intensifier control cavity is fluidly connected to the high pressure inlet via the check valve at the electronic control valve first position.

3. The fuel injector of claim 2 wherein the intensifier control cavity is fluidly connected to the high pressure inlet via the plunger cavity at the electronic control valve first position.

4. The fuel injector of claim 1 including an intensifier return spring operably positioned in the actuation cavity between the intensifier and the injector body.

5. The fuel injector of claim 1 including a needle biasing spring positioned in one of the nozzle cavity and the needle top cavity.

6. The fuel injector of claim 1 including a restricted orifice separating the plunger cavity from the electronic control valve.

7. The fuel injector of claim 1 wherein the unobstructed passage between the needle top cavity and the high pressure inlet includes a restricted orifice.

8. The fuel injector of claim 1 wherein the intensifier control cavity is fluidly connected to the high pressure inlet via the check valve and the plunger vaity at the electronic control valve first position;
an intensifier return spring operably positioned in the actuation cavity between the intensifier and the injector body;
a needle biasing spring positioned in the nozzle cavity;
a first restricted orifice separating the plunger cavity from the electronic control valve; and
wherein the unobstructed passage between the needle top cavity and the high pressure inlet includes a restricted orifice.

9. A fuel injection system comprising:
a high pressure common rail;
a low pressure reservoir;
fuel injectors that each include a needle top cavity and an actuation cavity fluidly connected via unobstructed passages to the high pressure common rail;
an electronic control valve associated with each fuel injector and being movable between a first position at which the intensifier control cavity is fluidly connected to the high pressure common rail, and a second position at which the intensifier control cavity is fluidly connected the low pressure reservoir;
the fuel injectors each include an intensifier and a needle with opposing hydraulic surfaces separated by guide surfaces and exposed to fluid pressure in the high pressure common rail when the electronic control valve is at the first position.

10. The fuel injection system of claim 9 wherein each fuel injector includes an intensifier return spring operably positioned to bias the intensifier toward a retracted position when the electronic control valve is in the first position.

11. The fuel injection system of claim 9 wherein each fuel injector includes a needle biasing spring operably positioned to bias the needle toward a position that blocks a nozzle cavity from a nozzle outlet when the electronic control valve is at the first position.

12. The fuel injection system of claim 9 wherein a plunger cavity disposed in each of the fuel injectors is separated from the high pressure common rail by a check valve; and
an intensifier control cavity disposed in each of the fuel injectors is fluidly connected to the high pressure common rail via the plunger cavity and the check valve at the electronic control valve first position.

13. The fuel injection system of claim 12 including a restricted orifice separating the plunger cavity from the electronic control valve.

14. The fuel injection system of claim 13 wherein the unobstructed passage between the needle top cavity and the high pressure inlet includes a restricted orifice.

15. The fuel injection system of claim 14 wherein each fuel injector includes an intensifier return spring operably positioned to bias the intensifier toward a retracted position when the electronic control valve is in the first position; and
each fuel injector includes a needle biasing spring operably positioned to bias the needle toward a position that blocks a nozzle cavity from a nozzle outlet when the electronic control valve is at the first position.

16. A method of operating an engine, comprising the steps of:
compressing air in an engine cylinder beyond an auto-ignition point of a liquid fuel;
maintaining opposing hydraulic surfaces of an intensifier of a plurality of fuel injectors exposed to fuel pressure in a high pressure common rail between injection events for the respective fuel injector;
initiating a fuel injection event by fluidly connecting an intensifier control cavity to a low pressure reservoir via an electronic control valve;
raising fuel pressure above that of the high pressure common rail during an injection event by moving an intensifier within the respective fuel injector; and
maintaining a needle top cavity at the fuel pressure of the high pressure common rail between and during injection events.

17. The method of claim 16 including a step of restricting fuel flow between the needle top cavity and the high pressure common rail with a restricted orifice.

18. The method of claim 16 wherein the electronic control valve closes a conical valve seat between injection events.

19. The method of claim 16 including a step of radially expanding at least one of the needle and intensifier to reduce a guide clearance during an injection event.

20. The method of claim 16 including a step of locating a needle biasing spring in a nozzle cavity; and
locating an intensifier return spring in an actuation cavity disposed in each fuel injector.
